(19) United States
(12) Patent Application Publication
(10) Pub. No.: US 2018/0202681 A1
(43) Pub. Date: Jul. 19, 2018

(54) AIR-CONDITIONER SYSTEM AND CONTROL METHOD

(71) Applicant: LG ELECTRONICS INC., Seoul (KR)

(72) Inventors: Myungkyoon KIM, Seoul (KR); Juntae Kim, Seoul (KR); Seunghwan Jung, Seoul (KR)

(21) Appl. No.: 15/869,319

(22) Filed: Jan. 12, 2018

(30) Foreign Application Priority Data
Jan. 12, 2017 (KR) 10-2017-0005517

(51) Int. Cl. F24F 11/38; G05B 13/02; F24F 11/54; F24F 11/58; F24F 11/64

(52) U.S. Cl. CPC F24F 11/38; G05B 13/026; H04L 67/12; F24F 11/58; F24F 11/64; F24F 11/54

(57) ABSTRACT

An air-conditioner system may include a plurality of air-conditioners, a management server and a database. The management server may be configured to receive air-conditioner data from the plurality of air-conditioners at a predetermined time interval and to analyze the received air-conditioner data to diagnose a state of the air-conditioners. The management server may store the received air-conditioner data in a memory. The management server may be configured to determine, based on a diagnostic result, whether the air-conditioner data corresponds to a normal, abnormal or failure state.

### CROSS-REFERENCE TO RELATED APPLICATION

This application claims the priority benefit of Korean Patent Application No. 10-2017-0005517, filed Jan. 12, 2017 in the Korean Intellectual Property Office, the subject matter of which is incorporated herein by reference.

### BACKGROUND

### 1. Field

The present disclosure relates to an air-conditioner system and a control method thereof. More specifically, the present disclosure relates to an air-conditioner system for diagnosing an air-conditioner by analyzing data of the air-conditioner and a control method thereof.

### 2. Background

An air conditioner may provide a comfortable indoor environment to humans by discharging cold air to a room to adjust an indoor temperature and purify the air of the room to create a pleasant indoor environment. The air conditioner may include an indoor unit (including a heat exchanger) installed in a room and an outdoor unit (including a compressor, a heat exchanger, and/or the like) that supplies a refrigerant to the indoor unit.

The air conditioner, in which the indoor unit (including the heat exchanger) and the outdoor unit (including the compressor, the heat exchanger, and the like) are separately controlled, may be operated by controlling power supplied to the compressor or the heat exchanger. The outdoor unit and indoor unit may be connected through a refrigerant pipe. Compressed refrigerant from the compressor of the outdoor unit may be supplied to the heat exchanger of the indoor unit through the refrigerant pipe. Heat-exchanged refrigerant in the indoor unit's heat exchanger may flow back into the outdoor unit's compressor through the refrigerant pipe. As a result, the indoor unit may discharge the cold or hot air into the room via the heat exchange using the refrigerant.

In air-conditioners, configurations of the indoor unit and the outdoor unit are different. Therefore, data to be measured or controlled may be different between the indoor unit and the outdoor unit. Thus, data of the indoor unit and data of the outdoor unit may be configured differently. Further, a plurality of indoor units may be connected to the outdoor unit, and a plurality of outdoor units may be provided. Thus, the amount of data transmitted from the indoor unit and the outdoor unit may increase in a proportional manner to a number of connected units.

Air-conditioners may be interconnected between buildings or interconnected in small groups. An air-conditioner system may transmit and receive the data, determine a condition of the corresponding air conditioner, and diagnose a failure thereof. Faults of the air-conditioners may be diagnosed by determining states of the air-conditioners by collecting and analyzing data of a plurality of air-conditioners dispersed in a plurality of regions.

Data transmitted from multiple air-conditioners may be stored in the database. A server that processes the data may analyze the data collected in the database to determine the condition(s) of the air-conditioner and diagnose the failure thereof.

However, regarding air-conditioner data, 70 to 150 kinds of data, for example, may be generated from one air-conditioner according to configuration of the corresponding air conditioner. Since the server may be connected to hundreds of thousands of air-conditioners, for example, the amount of data the server has to process may increase. Thus, it may take a lot of time for the server to analyze the data and derive results. Therefore, there may be a problem that the server cannot determine the state of the air-conditioner in real time.

As a result, the server may not instantaneously cope with the air-conditioner failure, and thus the air-conditioner may be damaged. Further, as the air-conditioner does not operate properly, it may cause inconvenience to the user. Therefore, there may be a need for an approach capable of processing data of a plurality of air-conditioners within a predetermined time.

### BRIEF DESCRIPTION OF THE DRAWINGS

Arrangements and embodiments may become apparent from the following description of preferred embodiments provided in conjunction with the accompanying drawings, in which like reference numerals refer to like elements and wherein:

FIG. 1 is a diagram showing configuration of an air-conditioner system according to an embodiment of the present disclosure;

FIG. 2 is a diagram showing a configuration of an air-conditioner system according to an embodiment of the present disclosure;

FIG. 3 is a block diagram schematically showing a control configuration of a management server of an air-conditioner system according to an embodiment of the present disclosure;

FIG. 4 is a block diagram in which the management server (of FIG. 3) is divided based on functions thereof;

FIG. 5 is an exemplary diagram to explain a data distribution processing of the management server of an air-conditioner system according to an embodiment of the present disclosure;

FIG. 6 is a diagram showing an example of data of an air-conditioner according to an embodiment of the present disclosure;

FIG. 7 is a flowchart showing a control method of an air-conditioner system according to an embodiment of the present disclosure;

FIG. 8 is a flowchart showing a data processing method of an air-conditioner system according to an embodiment of the present disclosure;

FIG. 9 is a flowchart to explain data processing and fault diagnosis of an air-conditioner system according to an embodiment of the present disclosure; and

FIG. 10 is an exemplary diagram illustrating an example of abnormal occurrence data of an air-conditioner system according to an embodiment of the present disclosure.

### DETAILED DESCRIPTION

For simplicity and clarity of illustration, the same reference numbers in different figures may denote the same or similar elements, and as such perform similar functionality. Descriptions and details of well-known steps and elements may be omitted for simplicity of the description. Furthermore, in the following detailed description, numerous specific details may be set forth in order to provide a thorough understanding of the present disclosure. However, it may be understood that the present disclosure may be practiced without these specific details. In other instances, well-known methods, procedures, components, and circuits may not have been described in detail so as not to unnecessarily obscure aspects of the present disclosure.

Examples of various embodiments may be illustrated and described further below. It may be understood that the description herein is not intended to limit the claims to the specific embodiments described. On the contrary, it may be intended to cover alternatives, modifications, and equivalents as may be included within the spirit and scope of the present disclosure as defined by the appended claims.

In the following description, usage of suffixes such as ‘module’, ‘part’ or ‘unit’ used for referring to elements may be given merely to facilitate explanation of the present disclosure, without having any significant meaning by itself. Therefore, ‘module’, ‘part’, and ‘unit’ may be mixedly used. Further, a control unit and other units included in the air-conditioner according to the present disclosure may be implemented by one or more processors and implemented by a hardware device.

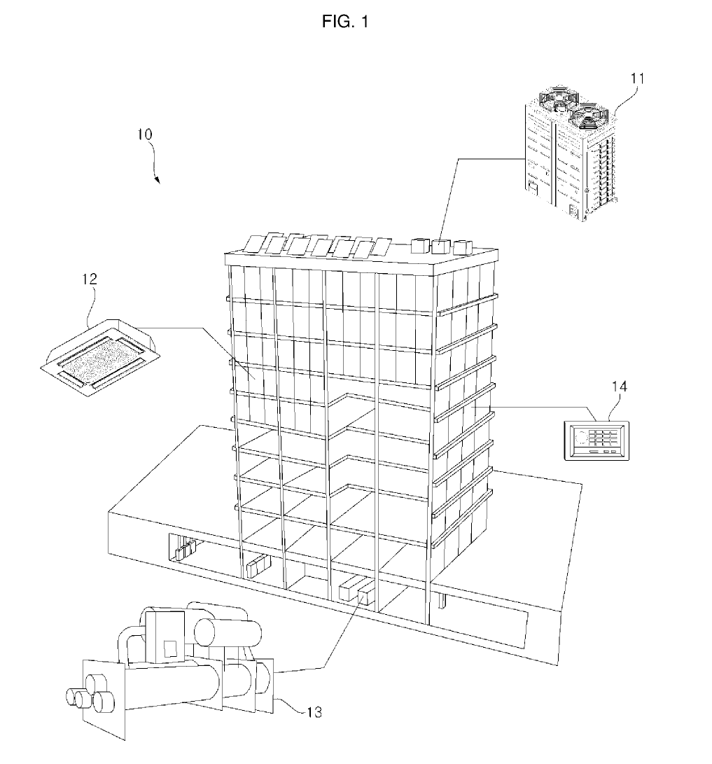

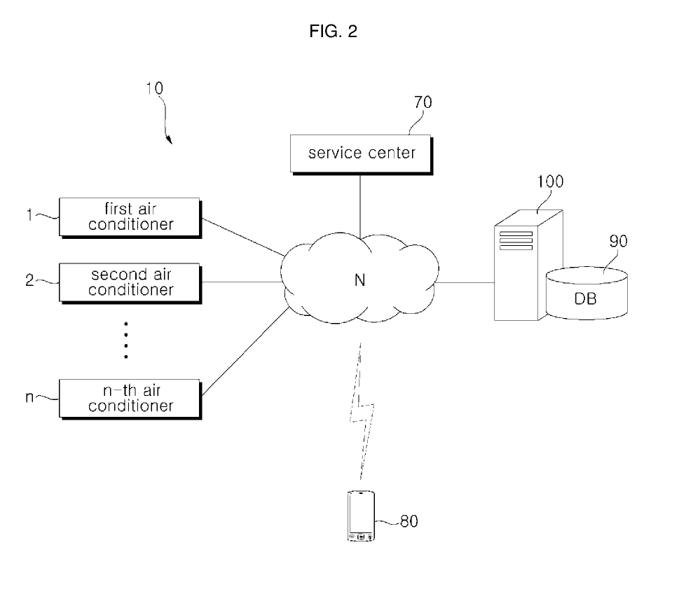

FIG. 1 is a diagram showing a configuration of an air-conditioner system (or air-conditioner) according to an embodiment of the present disclosure. FIG. 2 is a diagram showing a configuration of an air-conditioner system according to an embodiment. Other embodiments and configurations may also be provided.

Referring to FIG. 1, an air-conditioner 10 may include an outdoor unit 11, an indoor unit 12, and a controller 14. The controller 14 may be hardware (such as including a processor).

The air-conditioner 10 may include a chiller 13, an air conditioning unit, a ventilation unit, and/or the like. The air-conditioner 10 may include at least one of an air cleaning unit, a humidification unit, and a heater. In the air-conditioner, the units may be interconnected to operate in conjunction with operation of the indoor unit and the outdoor unit. Further, the air-conditioner 10 may operate in connection with a mobile device, a terminal, a security device, and/or an alarm device, etc. in a building.

The controller 14 may control operation of the indoor unit 12 and the outdoor unit 11 in response to an input user command. The controller 14 may periodically receive and store data on operation states of the indoor unit and the outdoor unit corresponding to the control thereof, and output the operation states on a monitoring screen (or display screen). The controller 14 may be connected to the indoor unit 12 to perform operation setting, lock setting, schedule control, group control, peak control for power use, and demand control for the indoor unit, for example.

The outdoor unit 11 may be connected to the indoor unit 12 via the refrigerant pipe, and supply refrigerant to the indoor unit. Further, the outdoor unit 11 may periodically communicate with a plurality of indoor units to transmit and receive data therebetween, and to change the operation according to the operation setting changed from the indoor unit.

The indoor unit 12 may include an electronic expansion valve for expanding refrigerant supplied from the outdoor unit 11, an indoor heat exchanger for heat-exchanging refrigerant, an indoor unit fan for allowing indoor air to flow into the indoor heat exchanger and for allowing the heat-exchanged air to be exposed to the indoor, a plurality of sensors, and control means for controlling the operation of the indoor unit.

The indoor unit 12 may include a discharge port for discharging the heat-exchanged air. The discharge port may be provided with a wind direction adjusting means for closing the discharge port and controlling the direction of the discharged air. The indoor unit may control rotating speed of the indoor unit fan, thereby controlling the intake air and the air to be discharged and controlling the air flow rate. The indoor unit 12 may further include an output unit (or display device) for displaying the operation status and setting information of the indoor unit and an input unit for inputting the setting data. The indoor unit 12 may transmit setting information for the air-conditioner operation to a remote controller connected thereto, output the information via the remote controller, and receive data.

The outdoor unit 11 may operate in a cooling mode or a heating mode in response to the data or controller control command received from the indoor unit 12 connected thereto, and the outdoor unit 11 may supply refrigerant to the indoor unit connected thereto.

In the presence of a plurality of outdoor units, each outdoor unit may be connected to a plurality of indoor units, and the refrigerant may be supplied to a plurality of indoor units via a distributor.

The outdoor unit 11 may include at least one compressor for compressing the refrigerant and discharging the pressurized gas refrigerant, an accumulator that separates the gas refrigerant and the liquid refrigerant from the refrigerant to prevent the non-vaporized liquid refrigerant from entering the compressor, an oil collection unit for collecting oil from the refrigerant discharged from the compressor, an outdoor heat exchanger for condensing or evaporating the refrigerant via heat exchange with the outside air, an outdoor unit fan for introducing air into the outdoor heat exchanger in order to facilitate the heat exchange of the outdoor heat exchanger, and for discharging the heat-exchanged air to the outside, a four-way valve that changes the refrigerant flow path according to the operation mode of the outdoor unit, at least one pressure sensor for measuring pressure, at least one temperature sensor for measuring temperature, and a control unit (or controller or processor) for controlling the operation of the outdoor unit and performing communication with other units. The outdoor unit 11 may include a plurality of sensors, valves, super-coolers, etc., although a description thereof may be omitted below.

As shown in FIG. 2, the air-conditioner system may include a plurality of air-conditioners 1 to n, a service center 70, a management server 100, a database 90 (or database device), and a terminal device 80 (or mobile terminal).

A plurality of air-conditioners 1 to n, which are installed at a plurality of locations, may be connected to the management server 100 over a network N.

The service center 70 may perform customer support, repair and inspection services for the air-conditioner, for example. The service center 70 may receive the user's complaints via the Internet or telephone network, remotely conduct the consultation, and dispatch the service engineer to the place (or location) where the air-conditioner is installed in response to the request for repair of the air-conditioner.

The service center 70 may be connected to the management server 100. When it is determined that the air conditioner is malfunctioning, the service center 70 may set a repair reservation for the air conditioner to the management server 100 and dispatch a service engineer accordingly.

The terminal device 80 may be connected to the air-conditioner via the network N to monitor the condition of the air-conditioner and to control the operation thereof. The terminal device 80 may access the service center 70 through the network to request a service. The terminal device 80 may have a communication module mounted therein and may perform network connection. The terminal device 80 may be implemented as a device equipped with an air-conditioner control application therein. For example, the terminal device may include a computer, a laptop, a smart phone, a PDA, a tablet PC, and/or the like.

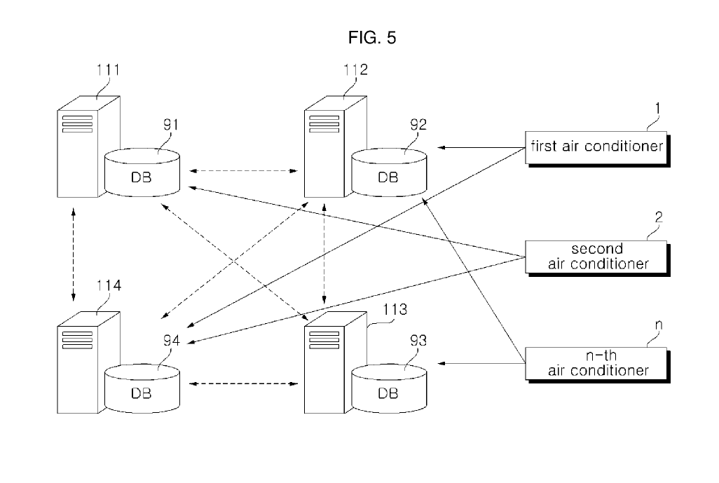

The management server 100 may analyze data received from the plurality of air-conditioners 1 to n 10 to determine the state of the air-conditioner and diagnose the failure thereof. The management server 100 may store the data of the plurality of air-conditioners in the database 90 and manage the stored data. The management server 100 may be constructed as a single server. Alternatively, as shown in FIG. 5, a plurality of servers may be interconnected to process the data in a distributed manner.

The management server 100 may be configured on a region basis or on a country basis to manage air-conditioner data and analyze air-conditioner operation.

The management server 100 may analyze and process the data of a plurality of air-conditioners to obtain statistical information including history of failure of the air-conditioner and power usage based on the environment or facility, and to analyze use pattern of the air-conditioner.

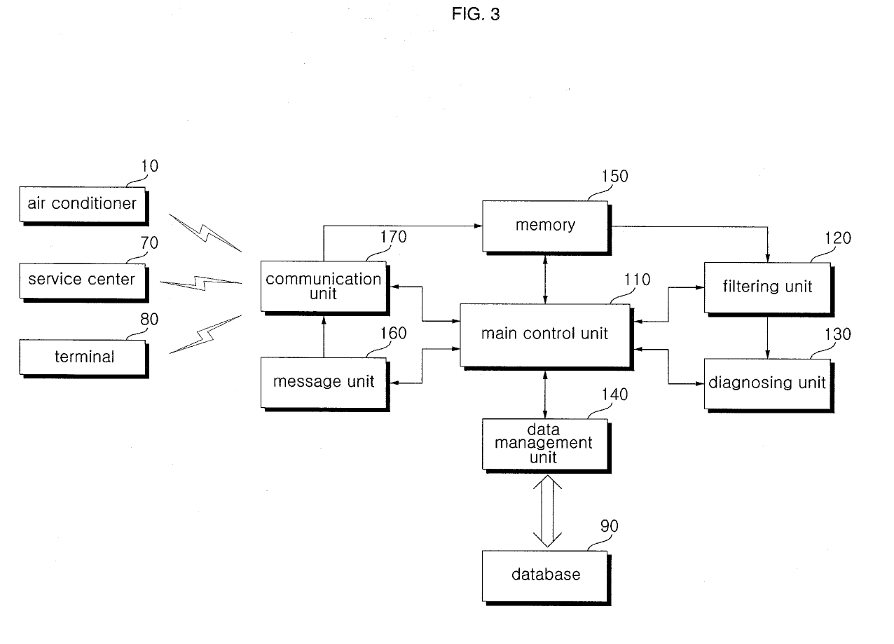

FIG. 3 is a block diagram schematically showing a control configuration of a management server of an air-conditioner system according to an embodiment of the present disclosure. Other embodiments and configurations may also be provided.

Referring to FIG. 3, the management server 100 may include a communication unit 170 (or a communication device), a memory 150, a filtering unit 120 (or a filtering device), a diagnosing unit 130 (or a diagnosing device), a message unit 160, a data management unit 140, and a main control unit 110 (or a main controller) for controlling overall operations. These components may each separately include at least a part of hardware.

The memory 150 may be a storage device inside the management server 100, and the memory 150 may store the data of the management server 100. The memory 150 may store control data for operation and data processing of the management server, data for troubleshooting, and data to be transmitted and received. The memory 150 may be implemented in a hardware manner, as a variety of storage devices such as ROM, RAM, EPROM, flash drive, hard drive, and/or the like.

The memory 150 may store the air-conditioner data received from the communication unit 170, store the diagnosis result from the diagnosing unit 130, and store a message generated by the message unit 160 (or provided from the message unit).

The memory 150 may temporarily store the air-conditioner data. The memory may temporarily store the air-conditioner data for data analysis before the air-conditioner data is stored in the database. Some of the air conditioning data stored in the memory may be discarded by the filtering unit (or filter) and the diagnosis may be performed with first remaining data only. In response to the diagnostic result of the diagnosing unit, only some data among the first remaining data may be stored in the database 90 and second remaining data among the first remaining data may be discarded.

The communication unit 170 (or communication device) may receive air-conditioner data from the air-conditioner 10 via the network N. When the communication unit 170 receives data from a plurality of air-conditioners 1 to n, the data may be stored in the memory 150. In this connection, the communication unit 170 may receive air-conditioner data by communicating with the stopped air-conditioner. That is, when the air-conditioner stops the operation for a predetermined time, or when the operation thereof stops after reaching a target temperature, or when the operation thereof stops after the operation is carried out according to the designated schedule, the communication unit 170 may transmit data of the air conditioner generated or sensed during the operation thereof to the management server. When the air-conditioner is in operation, its data change may be significant. Thus, when the air-conditioner is shut down, the air conditioner may send air-conditioner data to the server.

The communication unit 170 may be connected to the service center 70 and to the terminal device 80 through the network to transmit and receive data. The communication unit 170 may transmit a diagnosis result of the diagnosing unit 130 or a message generated from the message unit 160 to at least one of the service center 70, the terminal device 80 and the air-conditioner 10 in response to a control command of the main control unit 110.

The filtering unit 120 may filter the air-conditioner data stored in the memory 150. The filtering unit 120 may determine whether the air-conditioner data stored in the memory is machine readable data. The filtering unit 120 may discard the machine unreadable data or otherwise request that the data corresponding to the unreadable data be retransmitted.

The diagnosing unit 130 may analyze the air-conditioner data and perform parts diagnosis, operation status diagnosis and/or performance diagnosis on the air-conditioner.

The diagnosing unit 130 may analyze the air-conditioner data to determine whether the air-conditioner is in a normal state or in an abnormal state, for example. The diagnosing unit 130 may not derive a diagnostic result for data indicating a normal state if the air-conditioner is in a normal state.

The diagnosing unit 130 may analyze the air-conditioner data indicating an abnormal condition, and generate a diagnosis result including a solution to the abnormality, the cause of the abnormality, and/or the abnormality state. The diagnosing unit 130 may analyze air-conditioner data to distinguish between normal and malfunctioning conditions. In the event of a malfunctioning condition, the diagnosing unit 130 may generate a diagnostic result that includes the cause of the failure and a solution for resolving the failure.

The diagnosing unit 130 may compare information included in the air-conditioner data with a reference value to determine whether or not the abnormality is present. The diagnosing unit 130 may analyze the air-conditioner data in consideration of the comparison among the air-conditioners of a same type, the examination of factors according to the external environment, and the installation environments of the air-conditioner, and diagnoses the failure thereof accordingly.

In this situation, the abnormal state may include an example when there is a problem with the air-conditioner although the air-conditioner is operational, or an example when the performance or efficiency of the air-conditioner is degraded, or an example when the air-conditioner is currently operating although is likely to fail within a certain amount of time. On the other hand, the fault state is a state in which a fault of the air conditioner has already occurred and thus the air conditioner may not be operating.

The message unit 160 may generate (or provide) a message corresponding to the diagnosis result and transmit the generated message to the air-conditioner 10 and/or the terminal device 80. In this situation, messages may be generated in a form readable by the air-conditioner or terminal device. When the message is transmitted (or provided) to the terminal device, the message may be composed of a short message, a multimedia message, and/or a mobile web page.

The main control unit 110 (or main controller) may control the communication unit to transmit/receive data, and control data input/output into/from the memory.

The main control unit 110 may cause the air-conditioner data for the air-conditioner having the abnormal state to be stored in the database 90 together with the diagnosis result, according to the diagnosis result of the diagnosing unit. The main control unit 110 may delete the air-conditioner data for the air-conditioner determined to be normal by the diagnosing unit from the memory and discard the data.

The main control unit 110 may cause the diagnosed air-conditioner data to be discarded or stored in the database as described above. Thus, the main control unit 110 may delete the data from the memory so that the new data is stored in the memory.

When the diagnosis unit 130 is in an abnormal state or a failure state, the main control unit 110 may allow a diagnosis result to be sent to the service center via the communication unit 170 to perform the service reservation when dispatch of a service technician is required (or may be needed).

The main control unit 110 may cause the message generated by the message unit to be transmitted via the communication unit 170

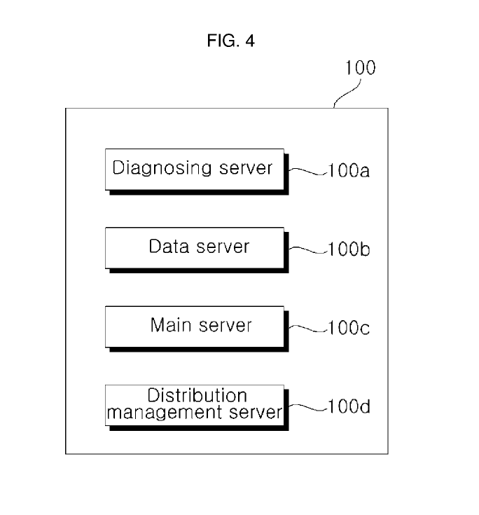

FIG. 4 is a block diagram in which the management server (of FIG. 3) is divided based on functions thereof. FIG. 5 is an exemplary diagram to explain a data distribution processing of the management server of the air-conditioner system according to an embodiment of the present disclosure. Other embodiments and configurations may also be provided.

Referring to FIG. 4, the management server 100 may be configured so that a plurality of servers may process data in a distributed manner. The management server 100 may include a diagnosis server 100a, a data server 100b, a main server 100c, and a distribution management server 100d. Each server may be a single server. Alternatively, each server may be configured such that a plurality of sub-servers may be configured to be interconnected. In the latter case, data may be processed in a distributed manner.

The diagnosis server 100a may analyze the air-conditioner data of the memory, filter the air-conditioner data, analyze the air-conditioner data, diagnose an abnormality or failure, and/or derive a solution therefrom. The diagnosis server 100a may compare the air-conditioner data of the same type. The diagnosis server 100a may compare previous and current data of the corresponding air-conditioner to diagnose an abnormality or failure thereof. The diagnosis server 100a may diagnose the air-conditioner based on the data of the external environment or the installation environment to diagnoses an abnormality or failure.

The data server 100b may store data in the database 90 connected thereto, and retrieve and transmit specific data according to a request. The data server 100b may cause the air-conditioner data to be stored in the database based on the diagnosis result according to the failure diagnosis.

The main server 100c may control data transmission/reception of the management server and data input/output into/from the management server. When the management server includes a plurality of servers, the distribution management server 100d may allocate data to each server to distribute the flow of each data to each sever such that the servers process the air-conditioner data in a distributed manner. When the diagnosis server is composed of a plurality of sub-servers, the distribution management server may assign air-conditioner data to each diagnosis sub-server.

As shown in FIG. 5, the management server 100 may include a plurality of servers 111 to 114, which process air-conditioner data.

One of the function-based servers of the management server, as shown in FIG. 4, for example, a diagnosis server may be composed of a plurality of servers as shown in FIG. 5. Thus, each diagnosis sub-server may analyze the air-conditioner data to diagnose the air-conditioner.

For example, the distribution management server may assign data to a plurality of servers 111 to 114. The data of the first air-conditioner 1 may be processed by the second server 112, the data of the second air-conditioner 2 may be processed by the first server 111 or processed by the fourth server 114 or the data of the nth air-conditioner n may be processed by the third server 113. An abnormality or failure may be diagnosed by comparing the air-conditioner data via sending and receiving data between the servers.

Each server may store, in its corresponding database 91 to 94, the corresponding processed air-conditioner data with an abnormal or failure state. In this situation, the databases 91 to 04 may be managed by the data server.

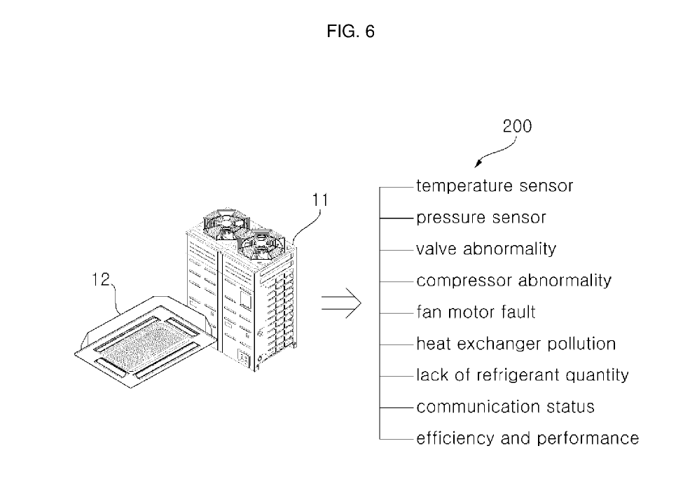

FIG. 6 is a diagram showing an example of data of an air-conditioner (or air-conditioner system) according to an embodiment of the present disclosure. Other embodiments and configurations may also be provided.

Referring to FIG. 6, the air-conditioner 10 may transmit a plurality of air-conditioner data 200 to the management server 100.

The air-conditioner 10 may collect data generated or measured from each unit (such as the outdoor unit 11 and the indoor unit 12) and transmit the collected data to the management server 100.

The management server 100 may analyze the air-conditioner data and perform parts diagnosis, operation status diagnosis and performance diagnosis for the air-conditioner.

The air-conditioner 10 may send the air-conditioner data 200 containing the following information to the management server 100: the plurality of information generated or measured during operation thereof, for example, measurements from the temperature sensors such as room temperature, outdoor temperature, refrigerant temperature, compressor pressure, piping pressure, etc., the operating voltage of the valve, the consumed voltage or current value of the valve, the abnormality of the valve, compressor fault, fan motor fault, heat exchanger pollution, lack of refrigerant quantity, information on communication status, efficiency and performance, etc.

The management server 100 may receive the air-conditioner data 200 from the globally installed plurality of air-conditioners via the network N, temporarily store the data in the memory (i.e., not the database), and analyze the data. After diagnosing the failure of the air-conditioner, the management server 100 may cause the air-conditioner data to be stored in the database 90.

The diagnosing unit 130 (of the management server 100) may diagnose sensor and component abnormalities, and predict efficiency and performance of the equipment based on the air-conditioner data. Accordingly, the diagnosing unit 130 (of the management server 100) may determine whether the corresponding air-conditioner is in a normal state, an abnormal state, or a failure state, thereby generating a diagnosis result.

In the situation where the air-conditioner is currently in normal operation (i.e., even if the data value is included in the normal range), the performance thereof may be degraded in response to the change over a certain period of time. In this example, the management server 100 may determine that the air conditioner is in an abnormal state. The management server 100 may compare not only the current data, but also data already stored in the database or data of other air-conditioners of the same model, or data of other air-conditioners having similar performance, to determine whether there is an abnormality for the corresponding air conditioner.

For example, the management server 100 may compare data of air-conditioners based on model year, installation location, model, structure, capacity, and historical data of the air-conditioners, and temperature, humidity, and season information, thereby diagnosing the air-conditioners.

The management server 100 may compare and analyze the values indicated by the cycle information between the air-conditioners from the air-conditioner data to derive the on-site average sensor value, the abnormal value, and the air-conditioner usage pattern. The management server 100 may analyze the sensor value fluctuation based on the external environments by correlating the weather information such as the external temperature, humidity, etc. from the air-conditioner data with the sensor values indicated from the cycle information. The management server 100 may diagnose the air-conditioner by comparing the cycle information with the actual installation environment and deriving the cycle operation trend according to the installation environment.

When the management server 100 determines that the air conditioner is in an abnormal state, the management server 100 may check the air conditioner before a failure occurs, and generate a diagnosis result to eliminate the abnormality.

When the management server 100 determines that the air conditioner is in an abnormal or failed state, the management server 100 may transmit the diagnosis result for the air-conditioner to the air-conditioner or the terminal device, and transmit (or provide) the diagnosis result and the failure history to the service center. The management server 100 may generate messages for an error or failure and transmit them (or provide them) as described above. The management server 100 may generate or transmit text based error notifications. Alternatively, the management server 100 may generate and transmit (or provide) a GUI-based diagnosis result as a report so that the user may confirm the diagnosis result.

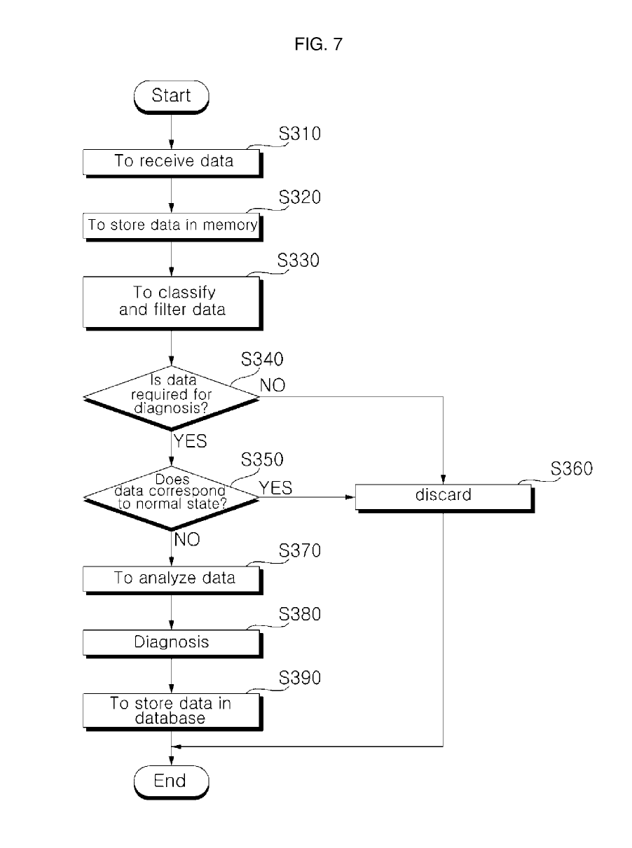

FIG. 7 is a flowchart showing a control method of an air-conditioner system according to an embodiment of the present disclosure. Other embodiments and configurations may also be provided.

In operation S310, the management server 100 may receive (via the communication unit 170) the air-conditioner data from the plurality of air-conditioners 1 to n connected thereto via the network N.

The main control unit 110 may store the received air-conditioner data in the memory 150 instead of the database in operation S320.

In operation S330, the filtering unit 120 may classify the air-conditioner data of the memory and determine whether the data is analyzed or whether there is an error in the data itself, thereby to filter the data.

The filtering unit 120 may analyze the air-conditioner data, and determine whether the corresponding data is necessary for diagnosis in operation S340. The filtering unit may exclude data at the time of diagnosis when the data is not necessary for determining abnormality or failure of the air-conditioner.

The main control unit 110 may cause the operation corresponding to the excluded data to be performed. For example, when the air-conditioner data is not data including the cycle information but is data requesting specific data, the main control unit 110 may retrieve and transmit the specific data as requested from the database.

When the requested operation is processed, the main control unit 110 may discard the specific data and delete the specific data from the memory.

Otherwise, when the data is the data needed for diagnosis (i.e., when the data is cycle data used for diagnosing an abnormality or failure of the air-conditioner), the diagnosing unit 130 may analyze this air-conditioner data. Thus, the diagnosing unit 130 determines, in operation S350 whether the data is data representing a normal state, an abnormal state, or data indicating a failure state.

When the data is data indicating the normal state (i.e., normal data, the diagnosing unit 130 excludes the data at the time of diagnosis. The main control unit 110 discards the excluded normal data and deletes the data from the memory in operation S360.

When the data is not normal data, the diagnosing unit 130 analyzes the data at step S370. Accordingly, the diagnosing unit 130 determines whether an abnormality or failure of the air-conditioner is present, analyzes the cause of the abnormality or failure, and obtains a solution thereto. In this way, the diagnosing unit 130 diagnoses the condition of the air-conditioner in operation S380.

The diagnosing unit 130 generates diagnostic results in terms of anomalies or failures.

The main control unit 110 responds to this diagnosis result and sends the diagnosis result to the service center. Alternatively, the main control unit 110 allows the diagnostic results to be sent to the air-conditioner or the terminal device 80 having control authority over the air-conditioner.

The main control unit 110 applies the diagnosis result to the message unit 160. Accordingly, the message unit 160 generates a message in different forms corresponding to the destinations receiving the diagnostic result.

For example, when the diagnostic result is transmitted to a terminal device (such as a smart phone or a computer capable of outputting data), the message unit generates a GUI based diagnostic result report or generates a web page. Further, when the diagnostic result is transmitted to a 2G terminal device capable of outputting only a short message, the message unit generates a short message. When the diagnosis result is transmitted to the service center, the message unit may generate a message including a diagnosis result, a failure history, and a repair request.

The main control unit 110 may transmit the message generated from the message unit using the communication unit 170.

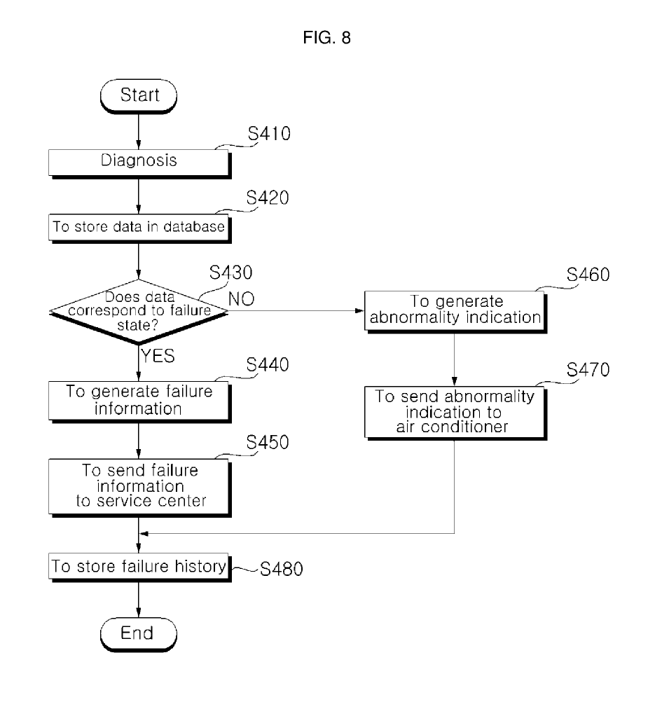

FIG. 8 is a flowchart showing a data processing method of an air-conditioner system according to an embodiment of the present disclosure. Other embodiments and configurations may also be provided.

Referring to FIG. 8, the management server 100 may analyze the air-conditioner data to diagnose the condition of the air-conditioner in operation S410.

The main control unit 110 may store the diagnosed air-conditioner data and the diagnosis result in the database 90 at operation S420.

In operation S430, the main control unit 110 may determine whether the corresponding air-conditioner is malfunctioning based on the diagnosis result.

When the corresponding air conditioner is failed, the message unit 160 may generate fault information in operation S440.

The main control unit 110 may transmit the generated failure information to the service center 70 using the communication unit 170 at operation S450. Thereby, the air-conditioner repair is requested.

The main control unit may transmit the failure information to the air-conditioner and a pre-registered terminal device having control authority over the air-conditioner.

Otherwise, when the air conditioner is not in a failure state, but is in an abnormal state based on the diagnosis result, the main control unit 110 may use the message unit 160 to generate a message for an abnormal state notification in operation S460.

In this situation, the message unit 160 may generate a message for an abnormal state notification in a format corresponding to the message destination. More specifically, the message unit may generate a message in the form of a textual document, a web page, a short message, a multimedia message, and/or a general notification.

The main control unit 110 may transmit the message for the abnormal state notification as generated by the message unit to the air-conditioner 10 using the communication unit 170 at operation S470. The main control unit 110 may transmit the message for the abnormal state notification to the pre-registered terminal device 80 having the control authority to the air-conditioner.

The main control unit 110 may store the diagnosis history according to the diagnosis result of the air-conditioner in operation S480.

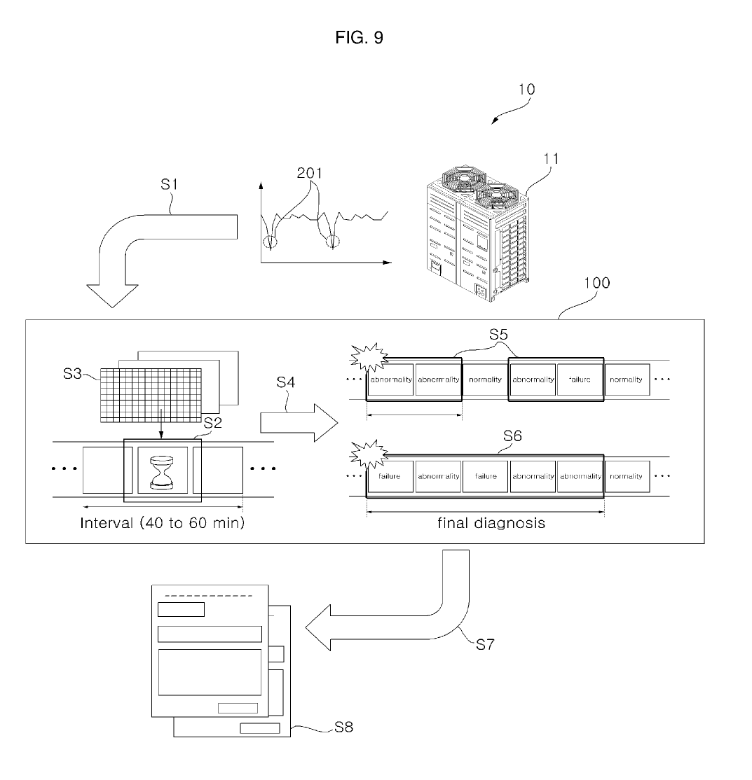

FIG. 9 is a flowchart to explain data processing and fault diagnosis of an air-conditioner system according to the embodiment of the present disclosure. Other embodiments and configurations may also be provided.

Referring to FIG. 9, the air-conditioner 10 may transmit air-conditioner data including a plurality of pieces of information including cycle information to the management server 100 via the network N S1. For example, the air-conditioner 10 may transmit cycle information including data including refrigerant pipe temperature, pressure, compressor operating frequency, etc. of the outdoor unit 11 as the air-conditioner data to the server 100. In case of sudden increase or decrease of data such as temperature, pressure, etc., the air-conditioner 10 may determine that there is an abnormality in 201 and may transmit the air-conditioner data to the management server.

The management server 100 may store the received air-conditioner data in the memory 150 at S2. The server 100 may analyze the air-conditioner data and diagnose the condition of the air-conditioner according to the diagnosis logic S3.

The management server 100 may store the received air-conditioner data in a database 90. Thereafter, the management server 100 may store the received air-conditioner data in memory instead of diagnosing the data. Thereafter, the management server 100 may analyze the air-conditioner data and diagnose the air-conditioner data, and then store the air-conditioner data in the database according to the diagnosis result.

The management server 100 may perform the diagnosis according to the diagnosis logic S4. The management server 100 may determine whether the air-conditioner data stored in the memory corresponds to an abnormal state, a normal state, or a fault state. The management server 100 may delete the air-conditioner data S5 corresponding to the normal state from the memory and discard the data.

A final determination may be made based on the air-conditioner data as determined as corresponding to the abnormality or failure state based on the diagnostic result. In some examples, data corresponding to the normal-state condition but associated with an anomaly or failure state may be included in the diagnostic results without being discarded.

The management server 100 may generate the final diagnosis result based on the air-conditioner data determined as corresponding to the abnormal or failure state S7.

For a single air-conditioner, a plurality of air-conditioner data may be generated. Thus, the management server 100 may combine the results for a plurality of air conditioner data to generate the diagnostic result S8.

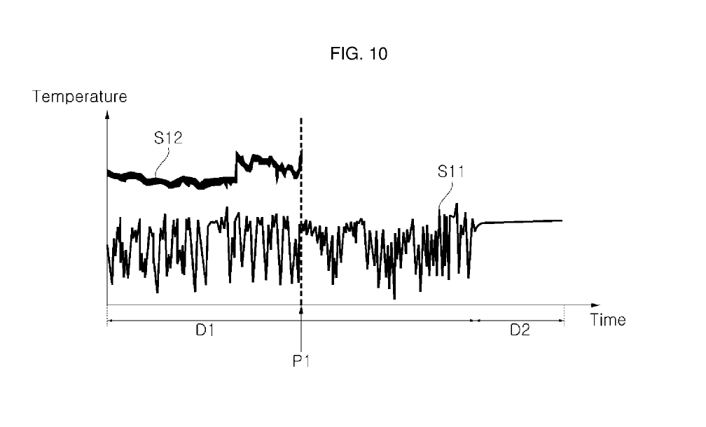

FIG. 10 is an exemplary diagram illustrating an example of abnormal occurrence data of an air-conditioner system according to an embodiment of the present disclosure. Other embodiments and configurations may also be provided.

Referring to FIG. 10, the management server 100 may analyze the data on the temperature of the air-conditioner. The server 100 may compare the measured temperature S12 with the temperature data S11 corresponding to the normal state, and thus determine whether there occurs the failure of the air conditioner.

The management server 100 may compare the measured temperature S12 with the temperature data of other air-conditioner corresponding to the normal state, the temperature information of other temperature sensors in the air-conditioner, and the previous temperature information, thereby to determine whether there occurs abnormality or failure.

When there is an abnormality in the temperature information related to the operation state, the management server may determine that the corresponding air conditioner has failed, and thus generate the corresponding diagnosis result, and transmits the result to the corresponding air-conditioner. Accordingly, the air-conditioner may cause the temperature sensor to stop in response to receiving the diagnosis result.

Thus, according to the present disclosure, the received air-conditioner data may be stored in the memory and processed immediately, and the classified air-conditioner data based on the processing result may be stored in the database. Thus, the condition of the air-conditioner may be diagnosed by processing the air-conditioner data within a predetermined time. This may make it possible to quickly cope with an abnormality or a failure, and to prevent a possible failure of the air conditioner. The management server may be connected to the service center to instruct the corresponding air-conditioner to be repaired when a failure thereof occurs. By classifying the air-conditioner data in terms of abnormality or failure and storing the corresponding data in the database, data management may be easy and database may be used more efficiently.

When all the elements that make up the embodiment of the present disclosure are described as being combined into a single group, the present disclosure is not necessarily limited to this embodiment. Within the scope of the present disclosure, all components may be combined into in multiple groups depending on the embodiment.

Embodiments of the present disclosure may provide an air-conditioner system and a control method thereof. It is an object of the present disclosure to provide an air-conditioner system for diagnosing an air-conditioner by processing air-conditioner data in real time and a control method thereof.

In a first aspect of the present disclosure, an air-conditioner system may comprise: a plurality of air-conditioners; a management server configured to receive air-conditioner data from the plurality of air-conditioners at a predetermined time interval and to analyze the received air-conditioner data to diagnose a state of the air-conditioners, wherein the management server has a memory; and a database configured to store the air-conditioner data therein, wherein the management server is configured to receive the air-conditioner data from the air-conditioners, to store the received air-conditioner data in the memory, and, thereafter, to analyze the air-conditioner data to diagnose the state of the air-conditioners, wherein the management server is configured to determine, based on a diagnostic result, whether the air-conditioner data corresponds to a normal, abnormal or failure state.

In one embodiment of the first aspect, the management server may include: a communication unit for receiving the air-conditioner data; a main control unit for storing the air-conditioner data in the memory; and a diagnosing unit for analyzing the air-conditioner data to determine whether the air-conditioner data corresponds to a normal, abnormal, or failure state.

In one embodiment of the first aspect, when the main control unit determines, based on the diagnosis result, that the air-conditioner data corresponds to the normal state, the main control unit is configured to delete the air-conditioner data from the memory and discard the air-conditioner data.

In one embodiment of the first aspect, when the main control unit determines, based on the diagnosis result, that the air-conditioner data corresponds to the abnormal or failure state, the main control unit is configured to store the air-conditioner data into the database.

In one embodiment of the first aspect, the diagnosing unit compares air-conditioner data of each air conditioner with previously stored air-conditioner data, data of other air-conditioner, or data of the same part in each air-conditioner, thereby to determine whether the air-conditioner data of each air-conditioner corresponds to the normal, abnormal, or failure state.

In one embodiment of the first aspect, the diagnosing unit is configured to analyze the air-conditioner data of each air conditioner to diagnose an abnormal state of a part of each air-conditioner, to predict efficiency and performance of each air-conditioner, and to diagnose a state of each air-conditioner.

In one embodiment of the first aspect, when a corresponding air-conditioner is currently operating normally but an efficiency or performance degradation thereof is predicted due to changes over a period of time, the diagnosing unit is configured to determine that the corresponding air-conditioner is in an abnormal state.

In one embodiment of the first aspect, the diagnosing unit is configured to analyze the air-conditioner data to perform parts diagnosis, operation state diagnosis, and performance diagnosis for the air-conditioner.

In one embodiment of the first aspect, the management server further includes a filtering unit for filtering air-conditioner data when the air-conditioner data corresponds to a normal state, wherein the filtering unit is configured to determine an error of the air-conditioner data, and to discards the data when the data has an error, wherein the filtering unit is configured to determine whether the air-conditioner data is necessary for diagnosis, and to exclude the data at a time of diagnosis by the diagnosing unit when the air-conditioner data is not necessary for diagnosis.

In one embodiment of the first aspect, the management server further comprises a message unit configured to generate a message based on the diagnostic result, wherein the message unit is configured to generate the message including the diagnosis result in a format corresponding to a destination receiving the diagnosis result, wherein the format includes a diagnostic result report, a web page, a text, a short message, and a multimedia message.

In one embodiment of the first aspect, when the air-conditioner data corresponds to the abnormal or failure state, the main control unit is configured to transmit a repair request to a service center via the communication unit, and to transmit the message to the air-conditioner issuing the air-conditioner data or a terminal device having control authority over the air-conditioner.

In a second aspect of the present disclosure, a method may be provided for controlling an air-conditioner system. A method may comprise: receiving air-conditioner data from a plurality of air-conditioners; storing the received air-conditioner data in a memory; diagnosing states of the air-conditioners by analyzing the air-conditioner data; filtering the air-conditioner data based on a diagnostic result; and determining, based on the diagnostic result, whether the air-conditioner data corresponds to a normal, abnormal or failure state.

In one embodiment of the second aspect, the filtering further includes deleting, from the memory, air-conditioner data corresponding to the normal state based on the diagnosis result.

In one embodiment of the second aspect, the filtering includes storing air-conditioner data corresponding to an abnormal state or a failure state in a database based on the diagnosis result.

In one embodiment of the second aspect, the diagnosing comprises comparing air-conditioner data of each air conditioner with previously stored air-conditioner data, data of other air-conditioner, or data of the same part in each air-conditioner, thereby to determine whether the air-conditioner data of each air-conditioner corresponds to the normal, abnormal, or failure state.

In one embodiment of the second aspect, the diagnosing comprises analyzing the air-conditioner data of each air conditioner to diagnose an abnormal state of a part of each air-conditioner, predicting efficiency and performance of each air-conditioner, and diagnosing a state of each air-conditioner.

In one embodiment of the second aspect, the diagnosing comprises, when a corresponding air-conditioner is currently operating normally but an efficiency or performance degradation thereof is predicted due to changes over a period of time, determining that the corresponding air-conditioner is in an abnormal state.

In one embodiment of the second aspect, the filtering comprises determining whether the air-conditioner data corresponds to a normal state.

In one embodiment of the second aspect, the method further comprises, when the air-conditioner data corresponds to the abnormal or failure state, transmitting a repair request to a service center; and transmitting a message indicating the abnormal or failure state to a terminal device having control authority over the air-conditioner issuing the air-conditioner data corresponding to the abnormal or failure state.

Thus, according to the present disclosure, the air-conditioner data may be stored in the memory and processed immediately, and the classified air-conditioner data based on the processing result may be stored in the database. Thus, the condition of the air-conditioner may be diagnosed by processing the air-conditioner data within a predetermined time. This may make it possible to quickly cope with an abnormality or a failure, and prevent a possible failure of the air conditioner.

The management server may be connected to the service center to instruct the corresponding air-conditioner to be repaired when a failure thereof occurs. By classifying the air-conditioner data in terms of abnormality or failure and storing the corresponding data in the database, data management may be easy and database may be used more efficiently.

The management server may analyze and process the data of the plurality of air-conditioners to obtain statistical information including history of failure of the air-conditioner and power usage based on the environment or facility, and to analyze use pattern of the air-conditioner.

According to the present disclosure, the server may diagnose abnormal conditions of sensors and parts in the air-conditioner in real time, check and repair air-conditioner based on the diagnosis result, and deal with the air conditioner in case of failure thereof. This may prevent air-conditioner damage, maintain constant performance, and improve air-conditioner efficiency.

It may be understood that when an element or layer is referred to as being “connected to”, or “coupled to” another element or layer, it can be directly on, connected to, or coupled to the other element or layer, or one or more intervening elements or layers may be present. In addition, it may also be understood that when an element or layer is referred to as being “between” two elements or layers, it may be the only element or layer between the two elements or layers, or one or more intervening elements or layers may also be present.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner system comprising:
a plurality of air-conditioners;
a management server configured to receive, at predetermined times, air-conditioner data from the plurality of air-conditioners and to analyze the received air-conditioner data, wherein the management server includes a memory; and
a database configured to store the air-conditioner data,
wherein the management server is configured to receive the air-conditioner data from the air-conditioners, to store the received air-conditioner data in the memory, and to analyze the air-conditioner data, stored in the memory, to diagnose a state of the air-conditioners,
wherein the management server is configured to determine, based on a diagnostic result, whether the air-conditioner data corresponds to a normal state, an abnormal state or a failure state.

2. The system of claim 1, wherein the management server includes:
a communication device to receive the air-conditioner data;
a main controller to store the air-conditioner data in the memory; and
a diagnosing unit to analyze the air-conditioner data to determine whether the air-conditioner data corresponds to the normal state, the abnormal state, or the failure state.

3. The system of claim 2, wherein when the diagnosis result is that the air-conditioner data corresponds to the normal state, the main controller is configured to remove the air-conditioner data from the memory.

4. The system of claim 2, wherein when the diagnosis result is that the air-conditioner data corresponds to the abnormal state or the failure state, the main controller is configured to store the air-conditioner data in the database.

5. The system of claim 2, wherein in order to determine whether the air-conditioner data of each air-conditioner corresponds to the normal state, the abnormal state, or the failure state, the diagnosing unit compares air-conditioner data of each air conditioner with previously stored air-conditioner data, data of another air-conditioner, or data of a same part in each air-conditioner.

6. The system of claim 2, wherein the diagnosing unit is configured to analyze the air-conditioner data of each of the air conditioners to diagnose the abnormal state of each of the air-conditioners, to predict efficiency and performance of each of the air-conditioners, and to diagnose the state of each of the air-conditioners.

7. The system of claim 6, wherein when a corresponding air-conditioner is currently operating normally and an efficiency or performance degradation is predicted due to changes over a period of time, the diagnosing unit is configured to determine that the corresponding air-conditioner is in the abnormal state.

8. The system of claim 2, wherein the diagnosing unit is configured to analyze the air-conditioner data to perform parts diagnosis, operation state diagnosis, and performance diagnosis for the air-conditioner.

9. The system of claim 2, wherein the management server includes a filtering device to filter air-conditioner data when the air-conditioner data corresponds to the normal state,
wherein the filtering device is configured to determine an error of the air-conditioner data, and to discard the data when the air-conditioner data has an error,
wherein the filtering device is configured to determine whether the air-conditioner data is necessary for diagnosis, and to exclude the data at a time of diagnosis by the diagnosing unit when the air-conditioner data is not necessary for diagnosis.

10. The system of claim 2, wherein the management server includes a message unit configured to provide a message based on the result of the diagnostic,
wherein the message unit is configured to provide the message, including the diagnosis result, in a format that includes a diagnostic result report, a web page, a text, a short message, and a multimedia message.

11. The system of claim 10, wherein when the air-conditioner data corresponds to the abnormal state or the failure state, the main controller is configured to transmit, via the communication device, a repair request to a service center, and to transmit the message to the air-conditioner corresponding to the air-conditioner data or a terminal device having authority over the corresponding air-conditioner.

12. A method for controlling an air-conditioner system, the method comprising:
receiving air-conditioner data from a plurality of air-conditioners;
storing, in a memory, the received air-conditioner data;
diagnosing a state of the air-conditioners by analyzing the air-conditioner data;
filtering the air-conditioner data based on a diagnostic result; and
determining, based on the diagnostic result, whether the air-conditioner data corresponds to a normal state, an abnormal state or a failure state.

13. The method of claim 12, wherein the filtering further includes removing, from the memory, air-conditioner data corresponding to the normal state.

14. The method of claim 12, wherein the filtering includes storing, in a database, air-conditioner data corresponding to the abnormal state or the failure state.

15. The method of claim 12, wherein in order to determine whether the air-conditioner data of each of the air-conditioners corresponds to the normal state, the abnormal state, or the failure state, the diagnosing includes comparing air-conditioner data of each air conditioner with previously stored air-conditioner data, data of another air-conditioner, or data of the same part in each air-conditioner.

16. The method of claim 12, wherein the diagnosing includes analyzing the air-conditioner data of each of the air conditioners to diagnose an abnormal state of a part of each of the air-conditioners, predicting efficiency and performance of each of the air-conditioners, and diagnosing the state of each of the air-conditioners.

17. The method of claim 16, wherein the diagnosing includes determining that the corresponding air-conditioner is in the abnormal state when a corresponding air-conditioner is currently operating normally and an efficiency or performance degradation is predicted due to changes over a period of time.

18. The method of claim 12, wherein the filtering includes determining whether the air-conditioner data corresponds to the normal state.

19. The method of claim 12, further comprising:
when the air-conditioner data corresponds to the abnormal state or the failure state, transmitting a repair request to a service center; and
transmitting a message indicating the abnormal state or the failure state to a terminal device having authority over the air-conditioner corresponding to the air-conditioner data corresponding to the abnormal state or the failure state.

20. An air conditioner system comprising:
a plurality of air-conditioners;
a management server configured to receive air-conditioner data from the plurality of air-conditioners and to diagnose a state of the air-conditioners as a normal state, an abnormal state or a failure state, wherein the management server includes a memory to store the air-conditioner data; and
a database configured to store the air-conditioner data,
wherein the management server is to store the received air-conditioner data in the database when the air-conditioner data is diagnosed as corresponding to the abnormal state or the failure state, and the management server is to remove the air-conditioner data in the memory when the air-conditioner data is diagnosed as corresponding to the normal state.
